(19) United States
(12) Patent Application Publication
(10) Pub. No.: US 2017/0144347 A1
(43) Pub. Date: May 25, 2017

(54) RTM Tool with Sealing System

(71) Applicant: Leichtbau-Zentrum Sachsen GmbH, Dresden (DE)

(72) Inventors: Werner Hufenbach, Dresden (DE); Martin Lepper, Dresden (DE); Jens Werner, Coswig (DE); Jörn Kiele, Dresden (DE)

(21) Appl. No.: 15/318,687

(22) PCT Filed: Jun. 18, 2015
(86) PCT No.: PCT/EP2015/063724

§ 371 Date: Dec. 14, 2016

(30) Foreign Application Priority Data
Jun. 18, 2014 (DE) 10 2014 211 640.6

(51) Int. Cl. B29C 45/26; B29C 45/64; B29C 45/02

(52) U.S. Cl. CPC B29C 45/2608; B29C 45/02; B29C 45/64; B29K 2883/00

(57) ABSTRACT

The subject matter of the present invention pertains to a RTM tool having a sealing system. This sealing system comprises an elastic sealing strip which is disposed in an undercut manner in one of at least two tool parts to be sealed. It is characterized in that the sealing strip is essentially stressed perpendicular to the sealing strip surface when the tool parts are closed by means of the part of the tool pressing on the sealing strip and deforming it into the sealing gap which is present, in the direction of the mould cavity. The sealing strip comes into contact with the moulding compound without forming a mechanical connection therewith.

### CROSS REFERENCE TO RELATED APPLICATIONS

This application is the U.S. national stage of International Application No. PCT/EP2015/063724, filed on 2015 Jun. 18. The international application claims the priority of DE 102014211640.6 filed on 2014 Jun. 18; all applications are incorporated by reference herein in their entirety.

### BACKGROUND

In processes which use Resin Transfer Moulding (RTM) in order to produce moulded parts or fibre-reinforced moulded parts, a moulding compound, in general an injection resin, is injected into the cavity of a mould via distribution lines. In this cavity, the moulding compound impregnates the fibre reinforcement which is optionally provided and is cured (usually actuated by heat).

The closed tool cavity is vacuum sealed from the environment by means of a sealing system. In the prior art, the fibre reinforcement is introduced into the cavity, preferably as a dry textile preform.

The plastic is injected into the tool cavity under pressure in order to fill the cavity with the plastic used as the moulding compound as quickly as possible.

When the tool is closed, two tool halves usually come into contact at a sealing surface. In the prior art, sealing grooves are disposed in this sealing surface in order to accommodate a sealing strip. The two tool halves are pressed together sufficiently strongly for the sealing action to enable the cavity to be evacuated. During subsequent injection, i.e. infusion of the moulding compound, the seal must be supported in a manner such that it can withstand the injection pressure.

DE102010043401A1 proposes placing what is known as a disposable seal in the sealing surface prior to each injection moulding step. This is considered to be an advance over cleaning the seal, as was previously the case. Even if the costs for the disposable seal are low, for mass production, considerable costs are incurred due to the continuous replacement of the seals.

In DE102011077463A1, a metallic seal is proposed which is tensed hydraulically. Applying pressure causes a sealing membrane to bulge or causes a sealing lip to enter the joint between the two tool parts. After injection and subsequent curing of the moulding compound, the tension in the seal can be relaxed by reducing the hydraulic pressure. Advantageously, constant replacement of the seals is not required. However, the complicated mechanics and the expensive repairs if the hydraulics are not properly sealed are disadvantageous.

DE102011077468A1 proposes the introduction of fibrous material impregnated with a plastic into the sealing surface as the seal. After closing the mould, but before injection of the moulding compound into the cavity, the fibrous material composite in the sealing region is consolidated by heating in order to produce the actual seal. The injection process is then carried out. A disadvantage is that the seal is removed after each injection procedure. Furthermore, expensive heating equipment is required in order to heat the sealing mass.

DE102005016932B3 describes the deformation of a sealing strip in a valve. This deformation occurs at a 45° angle with significant shear deformation of the sealing strip in order to increase the compression. This construction does not accommodate a pronounced sealing gap, as is required with seals in the RTM process. Furthermore, when the valve closes, the seal is subjected to a shear stress, which contributes to curtailing the anticipated service life.

In the case of known standard seals, multiple use is not possible because the sides of the sealing grooves which face the cavity become full of plastic, and thus an indentation is left (on the component) when the resin is unmoulded. Thus, the sealing strip either has to be removed from the sealing groove with it and remain on the component, or the groove and the sealing strip have to be cleaned after every injection. In general, the plastic adheres easily to the sealing strip, so that cleaning of the sealing strip is not without its problems. Mechanically removing the residues of resin from the sealing strip multiple times can also result in damaging the sealing strip. If residues of resin are not completely removed, then the seal is not tight for the next injection procedure and the tool could be damaged.

Changing the sealing strip after each injection generally has to be carried out manually, because the seal has to be pushed into the sealing groove. Furthermore, the sealing groove has to be cleaned. If residues remain, then the seal might not be tight and under some circumstances, the tool system could be damaged. The sealing strip is also very costly, and so cost-effectiveness drops.

The use of highly contoured sealing strips, in particular with hydraulic sealing systems, is also very costly, and thus usually uneconomical. Furthermore, such systems are relatively complicated and prone to problems.

Moreover, hydraulic seals are very prone to breakdowns, because if the hydraulic pressure fails, the sealing system no longer functions. In addition, the hydraulic side also has to be sealed against the tool cavity, and this is complicated and costly. The hydraulic pressure has to be higher than the internal pressure in the tool. Thus, the seal deforms as the internal pressure increases, so that thin films of resin flash are formed, which cause problems during subsequent cleaning.

### SUMMARY

The subject matter of the present invention pertains to a RTM tool having a sealing system. This sealing system comprises an elastic sealing strip which is disposed in an undercut manner in one of at least two tool parts to be sealed. It is characterized in that the sealing strip is essentially stressed perpendicular to the sealing strip surface when the tool parts are closed by means of the part of the tool pressing on the sealing strip and deforming it into the sealing gap which is present, in the direction of the mould cavity. The sealing strip comes into contact with the moulding compound without forming a mechanical connection therewith.

### DETAILED DESCRIPTION

Thus, the object is to propose a RTM tool with a sealing system which substantially overcomes the disadvantages of the prior art. In particular:
the shape of the groove contour in the tool should be as simple as possible in order to save tool production costs,
no expensive and breakdown-prone hydraulics should be employed,
a sealing strip which can be used multiple times should be employed.

The object is achieved by means of a RTM tool with a sealing system in accordance with claim 1. Advantageous embodiments are provided in the dependent claims.

In accordance with the invention, an elastic sealing strip is used in the RTM tool which sits in an undercut manner in a sealing groove and which is deformed when the tool is closed. Because it is configured so as to be undercut, the sealing strip is advantageously prevented from slipping out when in the non-deformed state. In the simplest case, the sealing strip has a circular cross-section. The sealing strip may, however, be slightly contoured with, for example, an elliptical or octagonal cross-section. The sealing strip has a characteristic length. The characteristic length is the maximum distance that can be generated between any 2 points on the edge of the cross-section of the sealing strip. As an example, the characteristic length for a circular cross-section is the diameter, and for an ellipse, it is the major axis (twice the major half axis).

Preferably, the sealing strip consists of silicone or another suitable elastic material from the prior art. In particular, the sealing strip does not make a mechanical connection with the matrix material (moulding compound, plastic) used in the RTM process.

The RTM tool with a sealing system in accordance with the invention is characterized in that upon closing the tool, the sealing strip is essentially only stressed perpendicular to the surface. In this regard, the closing tool part (which faces the seal) preferably comprises a tool bead which is moved essentially perpendicularly onto the seal. Preferably, the tool bead is disposed on the pressing tool part and is configured as a convexly shaped mould piece orientated towards the sealing strip which, during the closing movement of the tool part, contacts the sealing strip first and deforms the sealing strip essentially without stressing the sealing strip. In order to improve the operational life of the sealing strip, in the contact zone, slipping of the sealing strip on the pressing tool in the form of sliding friction should be avoided as far as possible in order to prevent the sealing strip from being damaged. In addition, the sealing strip only deforms elastically, so that the shear forces arising at the contact surface only result in reversible shear deformations. This too reduces degradation when used for lengthy periods and means that the sealing strip can be used multiple times.

The deflection (in cross-sectional view) of the direction of movement from the perpendicular, namely a line which passes through the centroid of the area (the centre in a seal with a circular cross-section) and the contact point at which the tool bead meets the exterior of the seal, is preferably between −44° and 44°, particularly preferably between −20° and 20° and more particularly preferably between −10° and 10°. In this manner, shear stresses on the sealing material are largely avoided. This means that when a sealing strip with a circular cross-section is used, as is preferable, then preferably, the direction of movement of the tool bead when the tool is being closed is directed towards the centre of the circular cross-section.

Preferably, the central plane of the sealing gap (25) is at an angle of between −89° and 89°, particularly preferably between −45° and 45° and more particularly preferably between −15° and 15° to the vector of action of the pressing tool part. Alternatively, the central plane of the sealing gap may also be at an angle of between 1° and 179°, particularly preferably between 45° and 135° and more particularly preferably between 75° and 105° to the vector of action of the pressing tool part. This has the advantage when the sealing cavity is primarily perpendicular to the vector of action of the pressing tool part in both directions.

More preferably, one or both of the tool parts which close against each other comprise concave regions in order to form a sealing cavity to specifically accommodate a portion of the deformed sealing strip. This sealing cavity corresponds exactly to at least a portion of the deformed seal. This ensures that the deformation of the seal occurs in essentially the same manner every time the tool closing procedure is carried out. Thus, the production of a specifically defined sealing gap is possible.

The sealing cavity preferably has a rounded shape (in cross-section) without edges. The sealing cavity is capable of accommodating at least 1%, particularly preferably at least 2%, more particularly preferably at least 3% of the cross-sectional area of the non-loaded sealing strip. Preferably, the seal completely fills the sealing cavity in the closed state of the tool.

The seal forms a sealing bead in the sealing gap and penetrates into the sealing gap up to the excrescence depth. This prevents the formation of moulding compound flash between the tool parts. The excrescence depth of the sealing strip into the sealing gap when the tool is closed is preferably at least 1%, particularly preferably at least 3% and more particularly preferably at least 6% of the characteristic length of the non-loaded sealing strip.

Preferably, in the deformed state, the sealing strip fills the sealing groove in a manner such that when the injection pressure is applied, a hydrostatic load is produced which pushes the seal against the wall of the sealing groove and the part of the seal that has been deformed into the sealing gap against its walls, and further improves the sealing action. The pressing tool part deforms the sealing strip in the seal in a manner such that in cross-section of the sealing strip, the absolute values for the principal strains are less than 150%, preferably less than 100% and particularly preferably less than 75%.

During injection, the heated moulding compound penetrates in a specifically defined, repeatable manner into the sealing gap and comes into contact therein with the deformed seal (sealing bead) without forming a mechanical connection therewith. The static pressure in the non-gelled moulding compound is preferably less than 250 bar, particularly preferably less than 175 bar and more particularly preferably less than 100 bar. After the moulding compound has cured, the tool is opened. The seal relaxes and reverts to its original cross-section. The moulding compound adhering to the sealing bead is loosened from the seal during the relaxation movement without causing damage to the seal. This results in almost no or only a very slight relative frictional movement, but rather, primarily a peeling force at the contact site between the seal and cured moulding compound. Because of its elasticity, the seal reverts to a shape which enables the plastic component to be unmoulded without any undercutting.

Advantageously, the unmoulded plastic component is not unmoulded with any flash adhering to the surfaces of the tools which would then have to be removed manually.

Because the tool surfaces of the sealing element are only subjected to roll-off forces rather than to friction when being deformed, the sealing material is preserved and it is possible to use the sealing strip multiple times. Extension of the sealing strip material advantageously only occurs within the elastic limit of the material.

In a preferred embodiment, the sealing groove is shaped in a manner such that it allows the sealing strip to be rolled off. In particular, the transitional graduations between the sealing groove and the sealing surface of the tool portion are rounded.

### BRIEF DESCRIPTION OF THE DRAWINGS

FIG. 1a to FIG. 1d diagrammatically show the relationships upon closing (FIG. 1a and FIG. 1b) and upon opening following the injection procedure (FIG. 1c and 1d) for the RTM tool having a sealing system in accordance with the invention.

FIG. 2, FIG. 3 and FIG. 4 diagrammatically show the RTM tool having a sealing system in accordance with the invention with a central plane of the sealing gap angled at 90° to the vector of action in the closed state after injection is complete.

### DETAILED DESCRIPTION OF THE PREFERRED EMBODIMENTS

In the following exemplary embodiments, the sealing strip consists of silicon rubber with an operating temperature range of −60° C. to 250° C. Other possible materials are suitable elastomers (for example: natural rubber (NR), perbunan (NBR), silicone (VMQ), EPDM, fluorinated rubber (Viton, FPM)).

The sealing strip has a circular cross-section with a diameter of 10 mm. However, sealing strips of this type with larger or smaller diameters, preferably in the range 4 mm to 20 mm, may also be employed.

The sealing strip is designed for compressive forces of up to a maximum pressure of 50 bar in the exemplary embodiment. In principle, applications of up to the maximum pressure for HP-RTM technology may be envisaged.

The moulding compound material which may be used may be a multi-component heat-cured epoxy resin system (typically in the temperature range of 40° C. to 160° C.); snap-cure systems with activation after a specific period or when a temperature threshold is exceeded may also be considered, as well as PUR resins or simple vinyl ester resins or polyester resins.

### Exemplary Embodiment 1

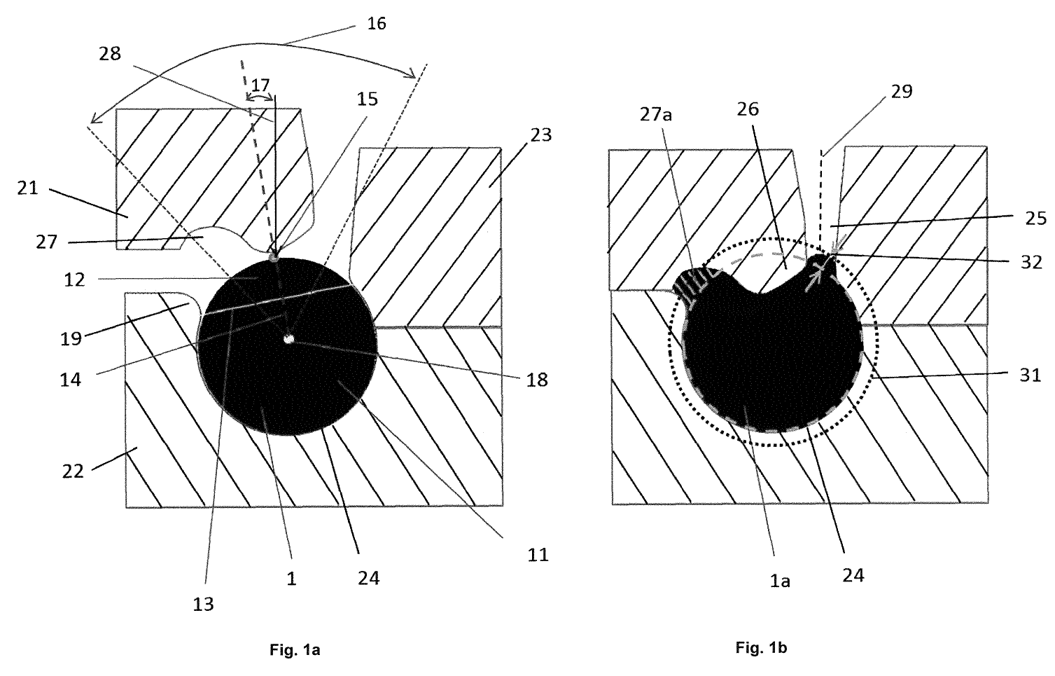

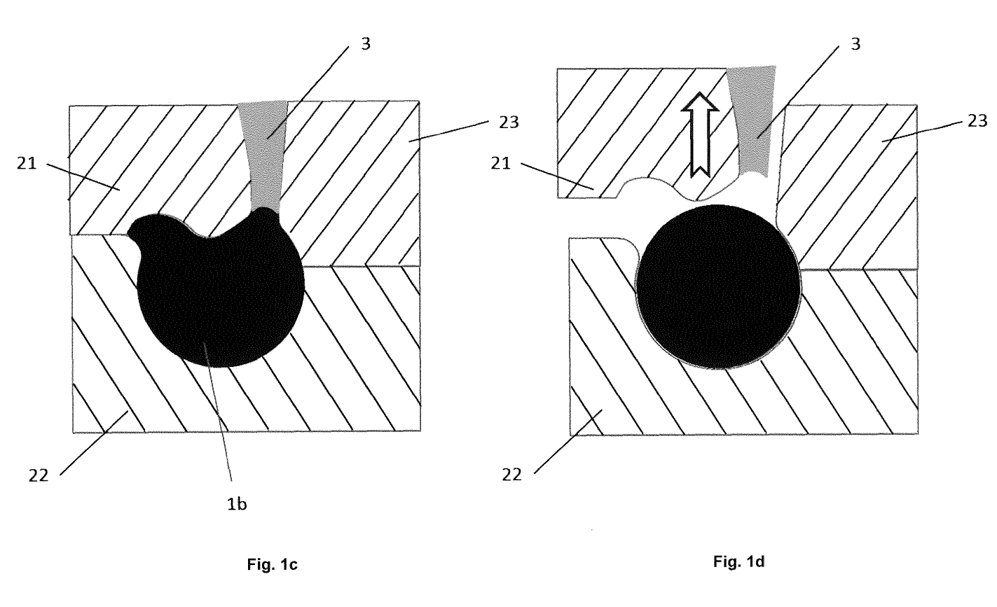

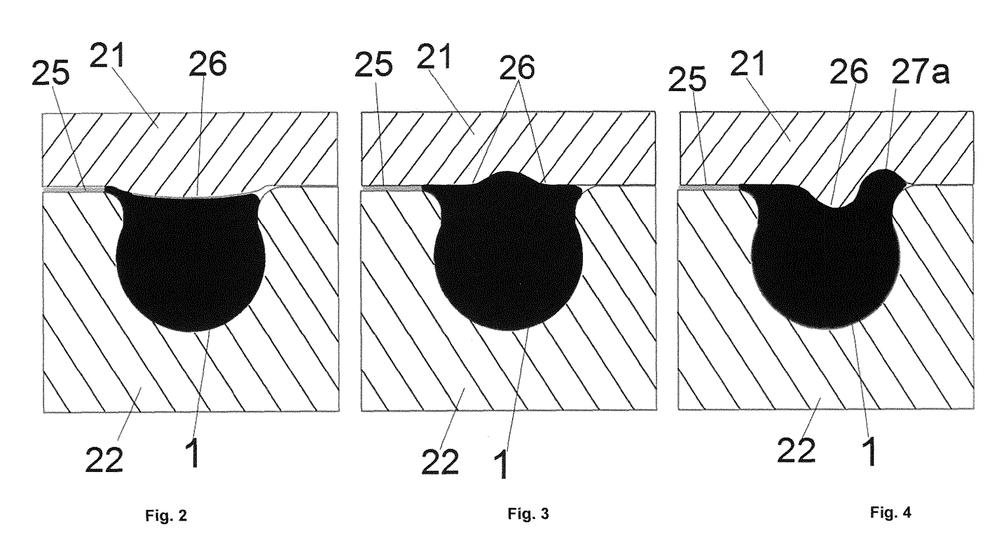

FIG. 1a shows the sealing strip (1) in the sealing groove (24). Because of the shape of the sealing groove (24) and sealing strip (1), a free sealing strip portion (12) is formed which protrudes out of the sealing groove (24) along with a trapped sealing strip portion (11). The two sealing strip portions (11, 12) meet at the smallest cross-sectional extent (13) of the sealing groove (24). Because the smallest cross-sectional extent (13) of the sealing groove (24) is shorter than the diameter of the sealing strip and the sealing groove (24) in the tool half (22) has a larger cross-section than the smallest cross-sectional extent (13), the sealing strip (1) is retained in the sealing groove (24) in an undercut manner.

When the upper tool half (21) is closed, the sealing strip (1) is deformed and thus rolls onto the bead (26) of the upper tool surface (21). It is thus specifically forced into the cavity (27) and the sealing gap (25). In the closed state (see FIG. 1b) the sealing strip (1a) is deformed in a manner such that it is stretched homogeneously around the bead (26) and forms an excrescence in the sealing gap (25) in the form of a semi-circular bead therein which seals it. A specifically defined fraction of the sealing strip is accommodated in the cavity (27a).

If the injection pressure is now applied (FIG. 1c), the moulding compound (3), in this case plastic, penetrates into the sealing gap (25). Because of the pressure, the seal (1b) in the sealing gap (25) is placed under more pressure, flattening the semicircle protruding into the sealing gap (25) and compressing the material against the walls of the tool.

Following curing (FIG. 1d) of the moulding compound (3), the tool (21, 22, 23) is opened. During the opening movement of the tool halves, the sealing strip (1) reverts to its original shape and now no longer lies against the plastic component (3). During the release movement of the sealing strip (1), it is peeled off the moulded part (3), in a manner that preserves the material. After unmoulding the plastic component (3), the latter is no longer in contact with the seal (1).

The exemplary embodiments corresponding to FIGS. 2, 3 and 4 show different shapes for the closing (upper) tool portion (21) and a sealing gap which is primarily disposed perpendicular to the vector of action.

FIG. 2 depicts a closing tool (21, 22) with a bead (26) which compresses the sealing strip (1) into its sealing groove and thus places the sealing strip (1) under a great deal of mechanical stress, obtaining a strong sealing action.

In the exemplary embodiment of FIG. 3, the closing tool part (21) has a depression in which the sealing strip (1) is fixed in its position while the closing process is being carried out.

The closing tool (21) in the exemplary embodiment of FIG. 4 has a very pronounced bead (26) which forces the sealing strip (1) in the direction of the mould cavity into the sealing gap (25), while the remaining displaced sealing strip (1) is specifically accommodated in the sealing strip cavity (27).

### LIST OF REFERENCE NUMERALS

1 sealing strip
1a deformed sealing strip with closed tool parts
1b deformed sealing strip with closed tool parts and moulding compound counter-pressure
11 trapped sealing strip portion
12 free sealing strip portion
13 smallest extent of the sealing groove
14 line from centroid of the area to first contact point of tool bead and sealing strip
15 first contact point of tool bead and sealing strip
16 angle at which the tool bead meets the sealing strip during the closing movement of the tool
17 angle between line (14) and the direction of closing movement of tool
18 centroid of the area of the sealing strip (in cross-section)
19 rounded transition between the sealing groove and the sealing surface of the tool
21 upper tool part
22 lower tool part
23 third tool part
24 sealing groove
25 sealing gap in direction of mould cavity
26 bead on upper tool part
27 cavity for accommodating a portion of the displaced sealing strip
27a filled cavity for accommodating sealing strip
28 vector of action
29 central plane of sealing gap
3 moulding compound
31 ring of maximum deformation of sealing strip in the sealing gap
32 excrescence depth of sealing strip into the sealing gap

1. A RTM tool having a sealing system, comprising an elastic sealing strip which is disposed in an undercut manner in one of at least two tool parts to be sealed, characterized in that
a. the pressing tool part comprises a mould piece which is configured so as to be convex in the direction of the sealing strip, which contacts the sealing strip first during the closing movement of the tool parts and enables the sealing strip to be deformed essentially without stressing the sealing strip with shear forces
b. when the tool parts are being closed, the sealing strip is loaded by means of the tool part pressing the sealing strip essentially perpendicularly to the sealing strip surface and is deformed into the sealing gap which is formed in the direction of the moulding cavity, and
c. the sealing strip comes into contact with the moulding compound without producing a mechanical connection therewith.

2. The RTM tool having a sealing system as claimed in claim 1, characterized in that the central plane of the sealing gap (25) is primarily at an angle of between −89° and 89°, preferably between −45° and 45° and particularly preferably between −15° and 15° to the vector of action of the pressing tool part.

3. The RTM tool having a sealing system as claimed in claim 1, characterized in that the central plane of the sealing gap (25) is primarily at an angle of between 1° and 179°, preferably between 45° and 135° and particularly preferably between 75° and 105° to the vector of action of the pressing tool part.

4. The RTM tool having a sealing system as claimed in claim 1, characterized in that the pressing tool part comprises a mould piece which is configured so as to be convex in the direction of the sealing strip, which contacts the sealing strip first during the closing movement of the tool parts and enables the sealing strip to be deformed essentially without sliding friction at the contact surfaces of the sealing strip.

5. The RTM tool having a sealing system as claimed in claim 1, characterized in that the angle between the line formed by the contact point and the centroid of the area and the vector for the travel direction of the pressing tool part has a value of between −44° and 44°, preferably between −20° and 20° and particularly preferably between −10° and 10°.

6. The RTM tool having a sealing system as claimed in claim 1, characterized in that the pressing tool part comprises concave regions which form a sealing strip accommodation cavity for sealing strip material which is displaced during the deformation of the sealing strip.

7. The RTM tool having a sealing system as claimed in claim 6, characterized in that the shape of the sealing strip accommodation cavity corresponds exactly to that of the deformed seal when the tool has been closed.

8. The RTM tool having a sealing system as claimed in claim 6, characterized in that the filled sealing strip accommodation cavity has an area of at least 1%, preferably 2% and particularly preferably 3% of the cross-sectional area of the unstressed sealing strip.

9. The RTM tool having a sealing system as claimed in claim 1, characterized in that the excrescence depth into the sealing gap is at least 1%, preferably 3% and particularly preferably 6% of the characteristic length of the sealing strip.

10. The RTM tool having a sealing system as claimed in claim 1, characterized in that the sealing strip is produced from silicone.

11. The RTM tool having a sealing system as claimed in claim 1, characterized in that the pressing tool part deforms the sealing strip in the seal in a manner such that in the cross-section of the sealing strip, the absolute values for the principal strains are less than 150%, preferably less than 100% and particularly preferably less than 75%.

12. The RTM tool having a sealing system as claimed in claim 1, characterized in that the static pressure in the ungelled moulding compound is less than 250 bar, preferably less than 175 bar and particularly preferably less than 100 bar.

13. The RTM tool having a sealing system as claimed in claim 1, characterized in that the RTM tool in the region of the seal is operated in a temperature range of −40° C. to +250° C.

14. The RTM tool having a sealing system as claimed in claim 1, characterized in that when the tool is opened, the seal loosens itself in an elastic manner from the solidified moulding compound in a peeling movement and reverts to its initial shape.
